(19) United States
(12) Patent Application Publication
(10) Pub. No.: US 2026/0091680 A1
(43) Pub. Date: Apr. 2, 2026

(54) INFORMATION DISPLAY APPARATUS

(71) Applicant: Honda Motor Co., Ltd., Tokyo (JP)

(72) Inventors: Keiichi Nishiyama, Tokyo (JP); Toshinori Saiki, Tokyo (JP); Yoshito Terayama, Tokyo (JP)

(21) Appl. No.: 19/336,414

(22) Filed: Sep. 22, 2025

(30) Foreign Application Priority Data
Sep. 27, 2024 (JP) 2024-168572

(51) Int. Cl. B60K 35/81; B60K 35/22; B60K 35/23; B60K 35/28; G06V 20/58

(52) U.S. Cl. CPC B60K 35/81; B60K 35/22; B60K 35/23; B60K 35/28; B60K 2360/168; G06V 20/582

(57) ABSTRACT

An information display apparatus includes: a display unit provided in a moving body; and a microprocessor configured to perform: recognizing a road sign, and controlling the display unit to display sign information corresponding to the road sign in a display area of the display unit based on a recognition result. The display unit includes a first display unit on which at least the sign information is displayed alone or a plurality of pieces of the sign information are displayed adjacent to each other, and a second display unit present at a position different from the first display unit. The microprocessor performs determining whether to display the sign information in the display area of the first display unit or the second display unit according to a type of the road sign, and controlling the display unit to display the sign information in the determined display area.

### CROSS-REFERENCE TO RELATED APPLICATION

This application is based upon and claims the benefit of priority from Japanese Patent Application No. 2024-168572 filed on Sep. 27, 2024, the content of which is incorporated herein by reference.

### BACKGROUND OF THE INVENTION

### Field of the Invention

The present invention relates to an information display apparatus for displaying information for driving assistance.

### Description of the Related Art

In recent years, efforts to provide access to sustainable transportation systems in consideration of vulnerable people among traffic participants are becoming active. In order to achieve this, research and development for further improving traffic safety and convenience are focused on research and development regarding driving support technology. Conventionally, as this type of device, there is known a device that, when a road sign is recognized from a front image of a subject vehicle obtained by an in-vehicle camera, switches whether or not to cause a display device to display information of a road sign, on the basis of a longitudinal traveling direction or a shift position of a subject vehicle (for example, see JP 2016-095756 A).

By the way, various road signs are provided on a road. Therefore, it is difficult to appropriately notify a driver of information corresponding to various road signs only by simply switching between display and non-display of the information of the road sign as in the device described in JP 2016-095756 A.

### SUMMARY OF THE INVENTION

An aspect of the present invention is an information display apparatus including: a display unit provided in a moving body; and a microprocessor. The microprocessor is configured to perform: recognizing a road sign around the moving body, and controlling the display unit to display sign information corresponding to the road sign in a display area of the display unit based on a result of the recognizing. The display unit includes a first display unit on which at least the sign information is displayed alone or a plurality of pieces of the sign information are displayed adjacent to each other, and a second display unit present at a position different from the first display unit. The microprocessor is configured to perform the controlling including determining whether to display the sign information in the display area of the first display unit or in the display area of the second display unit according to a type of the road sign, and controlling the display unit to display the sign information in the determined display area.

### BRIEF DESCRIPTION OF THE DRAWINGS

The objects, features, and advantages of the present invention will become clearer from the following description of embodiments in relation to the attached drawings, in which:

FIG. 1A is a diagram illustrating an example of a vehicle interior of a vehicle to which an information display apparatus according to an embodiment of the present invention is applied;

FIG. 1B is a diagram illustrating an example of a screen displayed in a display area of an instrument;

FIG. 2 is a block diagram illustrating a schematic configuration of an information display apparatus according to the embodiment of the present invention;

FIG. 3 is a diagram schematically illustrating a field of view of a driver during driving;

FIG. 4 is a flowchart illustrating an example of processing performed by the controller in FIG. 2;

FIG. 5A is a diagram illustrating display an example of a sign display area of the instrument;

FIG. 5B is a diagram illustrating display another example of the sign display area of the instrument; and

FIG. 6 is a diagram illustrating another example of the screen displayed in the display area of the instrument.

### DETAILED DESCRIPTION OF THE INVENTION

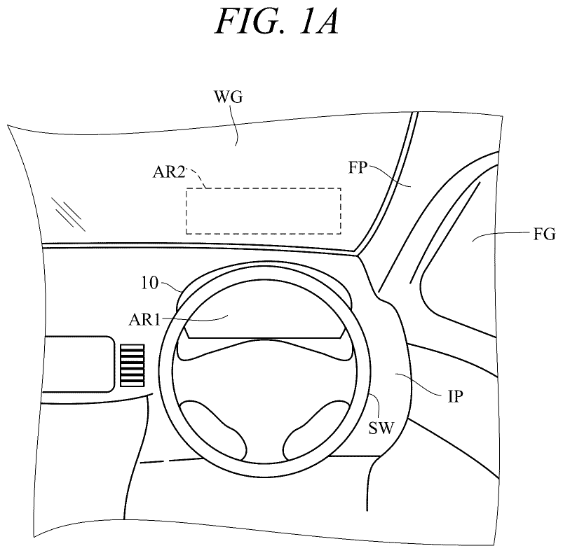

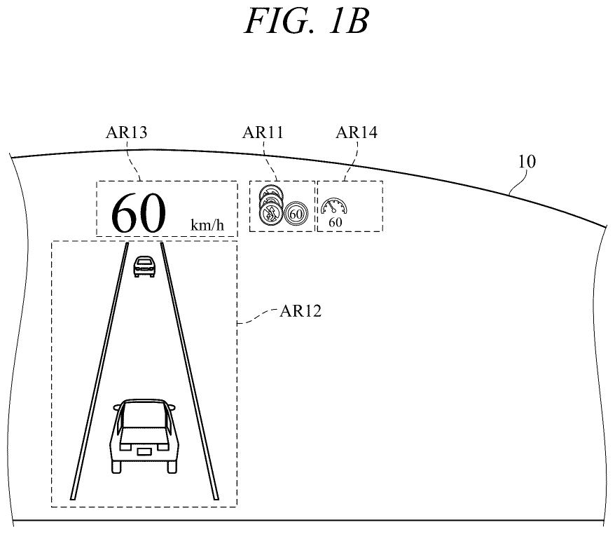

Hereinafter, an embodiment of the present invention will be described with reference to FIGS. 1A to 6. An information display apparatus according to the embodiment of the present invention is configured to control a display unit provided on an instrument of a vehicle. Note that a vehicle to which the information display apparatus according to the present embodiment is applied will be referred to as a subject vehicle to be distinguished from other vehicles, in some cases. Hereinafter, a case where the subject vehicle is a manually driven vehicle including advanced driver-assistance systems (ADAS) will be described as an example.

FIG. 1A is a diagram illustrating an example of a vehicle interior of a vehicle to which the information display apparatus according to the embodiment of the present invention is applied. FIG. 1A is a front view of a front portion of the vehicle interior of a right-hand drive vehicle provided with a driver's seat on a vehicle right side as viewed from a rear of the vehicle. Therefore, in FIG. 1A, a steering wheel SW is provided on a right side of a dashboard (also referred to as an instrument panel) IP extending in a vehicle width direction. Note that the information display apparatus according to the embodiment of the present invention is also applicable to a left-hand drive vehicle in which a driver's seat is provided on a vehicle left side.

A windshield glass WG is provided at a front end portion of the instrument panel IP so as to extend in a vehicle vertical direction and the vehicle width direction to partition the vehicle interior from the exterior. A right end portion in the vehicle width direction of the windshield glass WG is fixed to an inner end portion in the vehicle width direction of a front pillar FP provided on the vehicle right side. A front end portion of a front side glass FG is fixed to an outer end portion in the vehicle width direction of the front pillar FP. Note that a left end portion in the vehicle width direction of the windshield glass WG is fixed to a front pillar (not illustrated) provided on the vehicle left side.

On the vehicle right side of the instrument panel IP, an instrument 10 is provided so as to overlap the steering wheel SW in the vehicle width direction. The instrument 10 is a display having a display area AR1. In the display area AR1, a tachometer, a speed meter, and a direction indicator display lamp are displayed. In addition, in the display area AR1, information of a road sign (hereinafter, referred to as road sign information or simply sign information) recognized during traveling is displayed.

The windshield glass WG is provided with a display area AR2 of a head-up display (HUD). As illustrated in FIG. 1A, the display area AR2 is provided on the lower portion of the windshield glass WG so as to be located above the instrument 10. The HUD includes a projection device (not illustrated) provided on the upper portion of the instrument panel IP, and projects an image on the display area AR2 by the projection device.

FIG. 1B is a diagram illustrating an example of a screen displayed in the display area AR1 of the instrument 10 of FIG. 1A, specifically, a screen displayed in the display area AR1 when a following travel support function, which is one of driving support functions, is enabled.

The display area AR1 of the instrument 10 includes four display areas of a sign display area AR11, a support function state display area AR12, a speed display area AR13, and a vehicle state display area AR14.

In the sign display area AR11, information of a road sign (hereinafter, referred to as road sign information or simply sign information) recognized by an in-vehicle camera (a camera 4 to be described later) or the like while the subject vehicle is traveling is displayed. In an area on a left side (a left side in the drawing) of the sign display area AR11, regulatory signs such as turn prohibition, crossing prohibition, vehicle entry prohibition, temporary stop, and overtaking prohibition are displayed. On a right side (a right side in the drawing) of the sign display area AR11, a regulatory sign indicating a maximum speed is displayed. When a plurality of road signs are recognized during traveling, the plurality of road signs are displayed in a superimposed manner as illustrated in FIG. 1B. Note that, in FIG. 1B, the road signs in the sign display area AR11 are arranged so as to be adjacent to the right side and the left side, but the road signs may be arranged so as to be adjacent to each other in a direction (vertical direction, oblique direction, or the like) other than a right-left direction.

In the support function state display area AR12, information indicating the current state of the driving support function such as the following travel support function, a lane keeping support function, a congested driving support function, and a lane change support function is displayed. In the example of FIG. 1B, a state where the subject vehicle is traveling so as to follow a preceding vehicle is illustrated.

The current traveling speed of the subject vehicle is displayed in the speed display area AR13. In the vehicle state display area AR14, information indicating ON/OFF states of various functions of the vehicle including the driving support function, information indicating an abnormal state of the vehicle, and the like are displayed. In the example of FIG. 1B, information (icon) indicating that the following travel support function is operating with a set vehicle speed of 60 km/h is displayed.

Note that in the display area AR1, a tachometer, a speed meter, a direction indicator display lamp, a high-voltage battery indicator, a fuel system, and the like are displayed, but display areas corresponding thereto are not illustrated in order to simplify the drawing.

By the way, when the road sign installed on the traveling path of the subject vehicle is a road sign indicating a rule that the vehicle is to follow, such as a regulatory sign, a driver needs to perform a driving operation so that the subject vehicle travels according to the road sign. However, as illustrated in FIG. 1B, when all the sign information corresponding to the road signs that the driver is to follow is displayed in the sign display area AR11, the visibility of the sign information decreases. In this case, there is a risk that the driver cannot correctly recognize the display of the sign information and performs a wrong driving operation on the road sign. In this regard, in order to address such a problem, in the present embodiment, an information display apparatus is configured as follows.

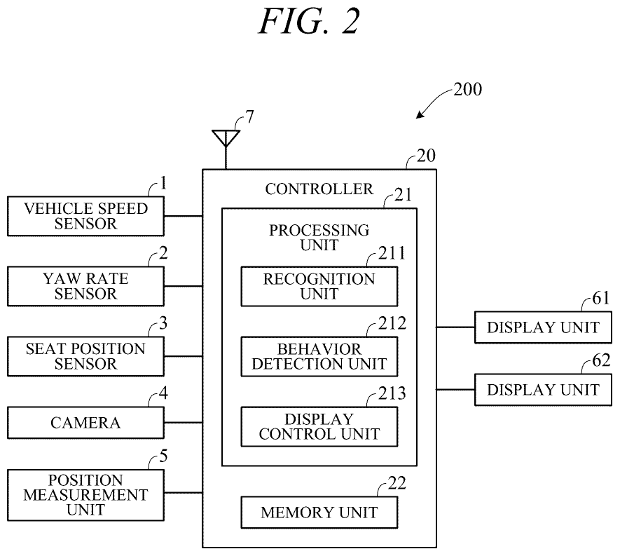

FIG. 2 is a block diagram illustrating a schematic configuration of an information display apparatus 200 according to the embodiment of the present invention. As illustrated in FIG. 2, the information display apparatus 200 includes a controller 20, a vehicle speed sensor 1, a yaw rate sensor 2, a seat position sensor 3, a camera 4, a position measurement unit 5, display units 61 and 62, and a communication unit 7.

The vehicle speed sensor 1 detects a traveling speed of the subject vehicle. The yaw rate sensor 2 detects a rotation angular velocity around a vertical axis of the center of gravity of the subject vehicle. A seat position sensor 3 detects a seat position of the driver's seat. The seat position of the driver's seat includes a height of a seat surface of a seat cushion of the driver's seat, a position of the seat cushion in a front-rear direction, a reclining angle of a seat back, and the like.

The camera 4 is a stereo camera having an imaging element (image sensor) such as a CCD or a CMOS. The camera 4 may be a monocular camera. The camera 4 detects an external situation around the subject vehicle. The camera 4 is attached to, for example, a predetermined position in a front portion of the subject vehicle, continuously captures an image of a space in front of the subject vehicle, and acquires an image of an object. The object includes the road sign provided on the traveling path of the subject vehicle.

The position measurement unit (global navigation satellite system (GNSS) unit) 5 includes a position measurement sensor that receives a positioning signal that has been transmitted from a positioning satellite. The position measurement satellite is an artificial satellite such as a global positioning system (GPS) satellite or a quasi-zenith satellite. The position measurement unit 5 uses positioning information that has been received by the position measurement sensor to measure a current position (latitude, longitude, and altitude) of the subject vehicle.

The display unit 61 constitutes the instrument 10 of FIG. 1A. The display unit 62 constitutes an HUD including the display area AR2 in FIG. 1A and a projection device that projects an image on the display area AR2.

The communication unit 7 communicates with various servers (not illustrated) via a network including a wireless communication network represented by the Internet network or a mobile phone network, and acquires map information, travel history information, traffic information, and the like from the server periodically or at an arbitrary timing. The network includes not only a public wireless communication network but also a closed communication network provided for every predetermined management area, for example, a wireless LAN, Wi-Fi (registered trademark), Bluetooth (registered trademark), and the like. The acquired map information is output to the memory unit 22. Accordingly, the road map information stored in the memory unit 22 is updated as needed. It is also possible to communicate with other vehicles via the communication unit 7.

The controller 20 includes a computer having a processing unit 21 such as a microprocessor (CPU), the memory unit 22 such as a ROM and a RAM, and other peripheral circuits (not illustrated) such as an I/O interface.

The memory unit 22 stores highly accurate road map information. The road map information includes road position information, information on a road shape (curvature or the like), information on a road gradient, position information on intersections and branch points, information on the number of lanes, information on the width of a lane and the position of each lane (information on the center position of a lane and the boundary line of the lane position), and position information on a landmark (traffic lights, signs, buildings, or the like) as a mark on the map.

The processing unit 21 includes an exterior environment recognition unit 211, a behavior detection unit 212, and a display control unit 213 as functional configurations.

The exterior environment recognition unit 211 recognizes an external situation around the subject vehicle. Specifically, the exterior environment recognition unit 211 performs pattern matching between a captured image for the front of the subject vehicle acquired by the camera 4 and images (correct images) of various road signs stored in advance in the memory unit 22, and recognizes a road sign on the traveling path of the subject vehicle included in the captured image. The exterior environment recognition unit 211 recognizes the presence or absence of a road sign and also the type of the road sign.

In addition, the exterior environment recognition unit 211 recognizes the structure and shape of the road in the traveling direction of the subject vehicle, on the basis of the captured image for the front of the subject vehicle acquired by the camera 4.

The behavior detection unit 212 detects the behavior of the subject vehicle. Specifically, in the behavior detection unit 212, the behavior detection unit 212 detects the behavior of the vehicle based on the driving operation of the driver, on the basis of the detection values of the vehicle speed sensor 1 and the yaw rate sensor 2. Note that the vehicle speed sensor 1 and the yaw rate sensor 2 are examples of internal sensors that detect the traveling state of the subject vehicle.

In addition to the vehicle speed sensor 1 and the yaw rate sensor 2, the internal sensor includes an acceleration sensor (not illustrated) that detects acceleration in the front-rear direction and the right-left direction of the subject vehicle, a rotation speed sensor (not illustrated) that detects a rotation speed of a traveling drive source, and the like. In addition, the internal sensor may include a sensor that detects a driving operation of the driver, for example, an operation of an accelerator pedal, an operation of a brake pedal, an operation of a steering wheel, and the like. The behavior detection unit 212 may detect the behavior of the vehicle by using an internal sensor other than the vehicle speed sensor 1 and the yaw rate sensor 2.

The display control unit 213 controls the display units 61 and 62 so as to display the sign information corresponding to the road sign in the display areas of the display units 61 and 62, on the basis of the recognition result of the exterior environment recognition unit 211. More specifically, the display control unit 213 determines whether to display the sign information in the display area AR1 of the display unit 61 (instrument 10) or in the display area AR2 of the display unit 62 (HUD), according to the type of the road sign. The display control unit 213 controls the display unit 61 and the display unit 62 to display the sign information in the determined display area. Specifically, the display control unit 213 transmits a display command for requesting display of the sign information to the display unit 61 or the display unit 62.

When the recognized road sign is a road sign (hereinafter, referred to as a regulatory sign) indicating an action regulation or a speed limit for the subject vehicle, the display control unit 213 transmits the display command to the display unit 61. At that time, the display control unit 213 transmits information designating the sign display area AR11 as a display target area to the display unit 61 together with the display command.

Even when the recognized road sign is a regulatory sign, in a case where the road sign is a regulatory sign indicating entry prohibition, the display control unit 213 transmits the display command to the display unit 62. Even in a case where the recognized road sign is a road sign indicating a road structure, the display control unit 213 transmits the display command to the display unit 62. At that time, the display control unit 213 determines the display position of the sign information in the display area AR2, on the basis of the road structure recognized by the exterior environment recognition unit 211. The display control unit 213 transmits information indicating the determined display position to the display unit 62 together with the display command.

When a predetermined condition is satisfied, the display control unit 213 transmits an end command for requesting end of display of the sign information to the display unit 61 or the display unit 62. More specifically, in a case where the exterior environment recognition unit 211 recognizes an auxiliary sign provided side by side with the road sign together with the road sign, when the subject vehicle has traveled a distance set in advance by the auxiliary sign after passing the road sign, the display control unit 213 transmits an end command to end the display of the road sign. In addition, when the exterior environment recognition unit 211 recognizes the auxiliary sign, which corresponds to the road sign being displayed, indicating the end of the regulation, the display control unit 213 transmits an end command to end the display of the road sign.

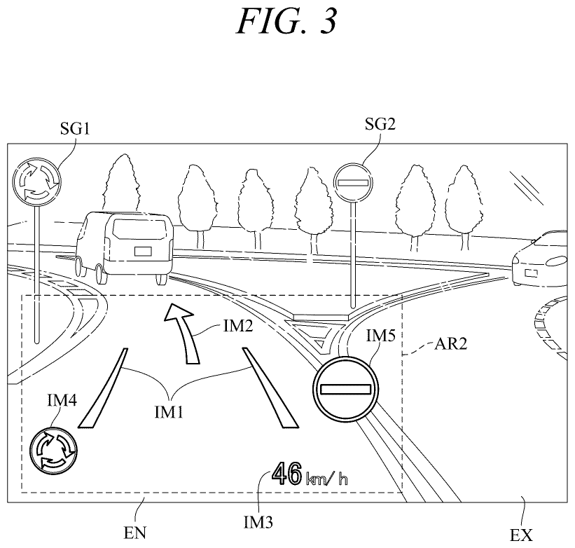

Here, determination of the display position of the sign information in the display area AR2 will be described. FIG. 3 is a diagram schematically illustrating a field of view of the driver during driving, specifically, a space in front of the vehicle visually recognized by the driver through the windshield glass WG. FIG. 3 illustrates an example of a field of view of the driver driving the subject vehicle traveling on an entry road EN to a circular intersection (roundabout). On the left side of the entry road EN, a sign SG1 indicating clockwise circulation in a roundabout is installed, and on the right side of the entry road EN, a sign SG2 indicating prohibition of entry from the entry road EN to an exit road EX is installed.

A broken-line rectangle illustrated in FIG. 3 schematically represents the display area AR2 on the windshield glass WG on which an image is projected by the projection device of the display unit 62 (HUD). In the display area AR2, images IM1 to IM5 are projected as information regarding driving support.

The image IM1 is information indicating a traveling position of the subject vehicle after a predetermined time. The image IM2 is information indicating the shape of the road in front of the vehicle recognized by the exterior environment recognition unit 211. An arrow represented by the image IM2 indicates that the road in front of the vehicle curves to the left. The image IM3 is information indicating a traveling speed of the subject vehicle. The images IM4 and IM5 are sign information corresponding to the signs SG1 and SG2 recognized by the exterior environment recognition unit 211.

The display control unit 213 estimates the position of the head (specifically, eyes) of the driver on the basis of the seat position of the driver's seat acquired by the seat position sensor 3. The display control unit 213 determines display positions of the images IM1 to IM5 in the display area AR2 on the basis of the estimated position of the head of the driver, the position of the display area AR2 on the windshield glass WG, and the structure and shape of the road in front of the vehicle recognized by the exterior environment recognition unit 211. At this time, the display control unit 213 determines the display positions of the images IM1 to IM5 such that the images IM1 to IM5 overlap with appropriate positions within the field of view of the driver. Specifically, the display control unit 213 predicts the traveling position of the subject vehicle after a predetermined time, on the basis of detection values of internal sensors such as the vehicle speed sensor 1 and the yaw rate sensor 2. The predicted traveling position is referred to as a predicted traveling position. The display control unit 213 determines the display position of the image IM1 such that the image IM1 overlaps with the vicinity of the predicted traveling position within the field of view of the driver. In addition, the display control unit 213 determines the display position of the image IM2 so as to correspond to the display position of the image IM1. In addition, the display control unit 213 determines the display position of the image IM3 indicating the traveling speed to be a predetermined position (a lower right portion in the example of FIG. 3). Further, the display control unit 213 determines the display position of the sign information (images IM4 and IM5) in the display area AR2. The display control unit 213 determines the display position of the image IM5 corresponding to the road sign indicating the entry prohibition, on the basis of the road structure recognized by the exterior environment recognition unit 211. Specifically, as illustrated in FIG. 3, the display position of the image IM5 is determined such that the image IM5 corresponding to the road sign indicating the entry prohibition overlaps with the vicinity of the boundary between the entry road EN and the exit road EX within the field of view of the driver. On the other hand, the display position of the sign information, such as the image IM4, simply indicating the road structure in the traveling direction is determined at a predetermined position (a lower left portion in the example of FIG. 3) in the display area AR2. Note that as illustrated in FIG. 3, the display control unit 213 may determine a display size of each piece of sign information such that the sign information corresponding to the entry prohibition is displayed larger than the sign information indicating the road structure in the traveling direction. In addition, the display control unit 213 may determine the display position of the sign information simply indicating the road structure in the traveling direction, on the basis of the road structure recognized by the exterior environment recognition unit 211.

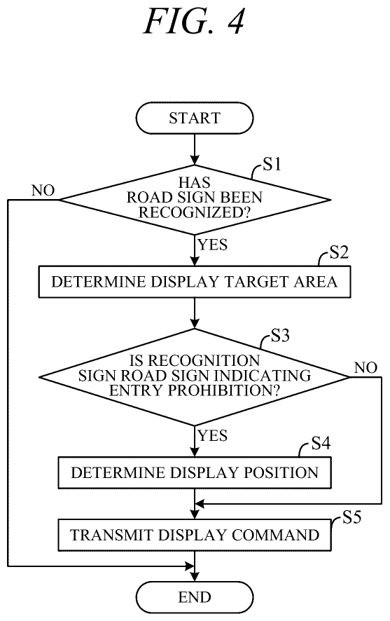

FIG. 4 is a flowchart illustrating an example of processing performed by the controller 20 in FIG. 2 according to a predetermined program. The processing illustrated in this flowchart is repeated at a predetermined cycle, for example, when a predetermined driving support function such as a sign recognition function is enabled in response to a command of the driver.

First, in step S1, it is determined whether a road sign has been recognized. When a negative determination is made in step S1, the processing is ended. When an affirmative determination is made in step S1, the display target area of the recognized sign is determined in step S2 on the basis of the type of the road sign (hereinafter, referred to as a recognition sign) recognized in step S1. Specifically, when the recognition sign is a regulatory sign, the display target area is determined as the sign display area AR11, and when the recognition sign is a road sign indicating a road structure or a road sign indicating entry prohibition, the display target area is determined as the display area AR2.

In step S3, it is determined whether the recognition sign is the road sign indicating entry prohibition. When a negative determination is made in step S3, the processing proceeds to step S5. When an affirmative determination is made in step S3, in step S4, the display position of the recognition sign, specifically, the display position of the recognition sign in the display area AR2 is determined on the basis of the road structure recognized by the exterior environment recognition unit 211.

In step S5, a display command for the recognition sign is transmitted to the display unit 61 or the display unit 62 together with the information indicating the display target area determined in step S2. When the display position is determined in step S4, information indicating the display position is also transmitted.

According to the present embodiment, the following operations and effects can be achieved.

(1) The information display apparatus 200 includes a display unit which is provided in a subject vehicle as a moving body, the exterior environment recognition unit 211 which recognizes a road sign around the subject vehicle, and the display control unit 213 which controls the display unit to display sign information corresponding to the road sign in a display area of the display unit, on the basis of a recognition result of the exterior environment recognition unit 211. The display unit includes the display unit 61 as a first display unit on which at least sign information is displayed alone or a plurality of pieces of sign information are displayed adjacent to each other, and the display unit 62 as a second display unit which is present at a position different from the first display unit. The display control unit 213 determines whether to display the sign information in the display area AR1 of the display unit 61 or in the display area AR2 of the display unit 62, according to a type of the road sign, and controls the display unit to display the sign information in the determined display area. In this way, by making a display location different according to the type of the road sign, it is possible to notify an occupant of the information regarding the road sign more effectively and easily as compared with a case where all types of road signs are displayed at the same location.

(2) The display unit 61 and the display unit 62 are different displays. More specifically, the display unit 61 is a single display (instrument 10) provided on an instrument panel of the subject vehicle. The display unit 62 is a head-up display. With this configuration, the road sign can be effectively displayed on each of the different displays according to the type of the road sign. In addition, the road sign can be effectively displayed according to a type of the display.

(3) In the display area AR1 (more specifically, the sign display area AR11) of the display unit 61 (instrument 10), sign information corresponding to a road sign indicating an action regulation or a speed limit for the subject vehicle is displayed. In the display area AR2 of the display unit 62 (HUD), sign information corresponding to a road sign indicating a road structure or a road sign indicating entry prohibition is displayed. In this way, by displaying, on the instrument 10 side provided in the instrument panel, a road sign relating to an action regulation that does not require an emergency measure or response by the driver or a road sign applied over a certain section, it is possible to suppress an excessive warning to the occupant. Note that when the sign information corresponding to the road sign indicating the road structure and the sign information corresponding to the road sign indicating entry prohibition are displayed in the display area AR2 of the display unit 62 (HUD), the sign information corresponding to the road sign indicating entry prohibition may be displayed larger than the sign information corresponding to the road sign indicating the road structure (FIG. 3).

(4) The exterior environment recognition unit 211 further recognizes a road structure in the traveling direction of the subject vehicle. The display control unit 213 determines a display position of the sign information in the display area AR2 of the display unit 62 (HUD), on the basis of the road structure recognized by the exterior environment recognition unit 211. With this configuration, the road sign can be effectively displayed on the HUD in accordance with the road structure in the traveling direction of the subject vehicle.

The above embodiment can be modified into various forms. Hereinafter, modifications will be described. In the above embodiment, the exterior environment recognition unit 211 as a recognition unit recognizes a road sign, a structure of a road, and a shape of the road, on the basis of a captured image for the front of the subject vehicle acquired by the camera 4. However, the recognition unit may recognize the road sign, the structure of the road, and the shape of the road, on the basis of map information (high-precision map information) stored in the memory unit 22 and a current position of the subject vehicle measured by the position measurement unit 5. In addition, the road sign on the traveling path may be recognized on the basis of information received from a roadside device through road-to-vehicle communication via the communication unit 7.

In the above embodiment, the information display apparatus 200 is applied to a manually driven vehicle including an ADAS as a moving body, but the information display apparatus 200 is also applicable to a self-driving vehicle or the like. In addition, the moving body to which the information display apparatus 200 is applied may be a self-propelled robot, instead of the vehicle.

In the above embodiment, when the exterior environment recognition unit 211 recognizes a regulatory sign indicating an action regulation on the subject vehicle, the display control unit 213 transmits, to the display unit 61 (instrument 10), a display command for sign information corresponding to the regulatory sign. However, in a case where the road sign recognized by the exterior environment recognition unit 211 is a regulatory sign, when a behavior violating the action regulation is detected by the behavior detection unit 212 after transmitting the display command, the display control unit may transmit a highlighting command to the display unit 61 such that the sign information corresponding to the regulatory sign being displayed is highlighted. Accordingly, it is possible to effectively call attention to the occupant. The highlighting command may be a command for requesting blinking display of the sign information corresponding to the regulatory sign being displayed, a command for requesting enlarged display of the sign information, or other commands.

In addition, when the road sign recognized by the exterior environment recognition unit 211 is a regulatory sign indicating an action regulation on the subject vehicle, the display control unit may wait for transmission of the display command until a behavior violating the action regulation is detected by the behavior detection unit 212. That is, when the behavior violating the action regulation is detected by the behavior detection unit 212, the display command for sign information corresponding to the regulatory sign may be transmitted to the display unit 61 or the display unit 62.

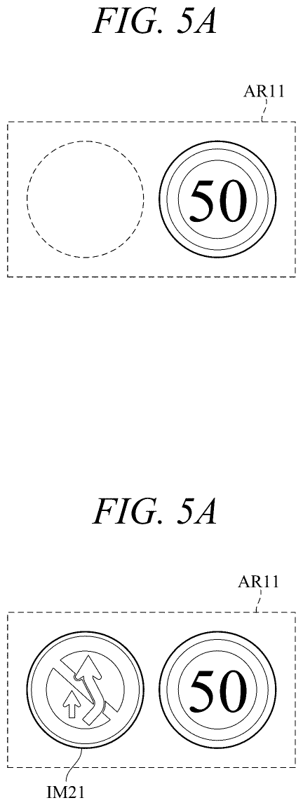

FIGS. 5A and 5B are diagrams illustrating display examples of the sign display area AR11 of the instrument 10. FIGS. 5A and 5B illustrate display examples of the sign display area AR11 when the overtaking prohibition regulatory sign is recognized. When the exterior environment recognition unit 211 recognizes the overtaking prohibition regulatory sign, the display control unit waits for transmission of the display command until an overtaking behavior is detected by the behavior detection unit 212 (FIG. 5A). A broken-line circle in FIG. 5A schematically indicates that display of sign information (an image IM21 in FIG. 5B) corresponding to the overtaking prohibition regulatory sign is on standby. Thereafter, when the overtaking behavior is detected by the behavior detection unit 212, the display control unit transmits, to the display unit 61, a display command for the sign information IM21. Accordingly, the sign information IM21 is displayed in the sign display area AR11 (FIG. 5B). According to this configuration, when the subject vehicle is traveling according to the regulatory sign, the display of the regulatory sign is suppressed, so that excessive attention can be prevented.

In addition, in the above embodiment, when the road sign recognized by the exterior environment recognition unit 211 is a regulatory sign, the display control unit 213 transmits, to the display unit 61, information designating the sign display area AR11 as a display target area together with a display command for the road sign. However, when the road sign is a specific regulatory sign (hereinafter, referred to as a specific regulatory sign), the display control unit may transmit, to the display unit 61, information designating an area other than the sign display area AR11 as a display target area together with a display command for the road sign.

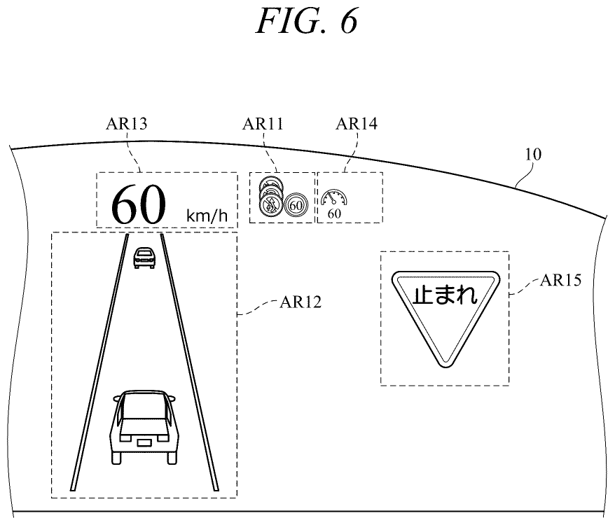

FIG. 6 is a diagram illustrating another example of the screen displayed in the display area AR1 of the instrument 10. In the display area AR1 of the instrument 10 of FIG. 6, the sign display area AR11 as a first display area and a sign display area AR15 as a second display area separated from the sign display area AR11 are provided. When the road sign recognized by the exterior environment recognition unit 211 is a specific regulatory sign, the display control unit may transmit, to the display unit 61 (instrument 10), information designating the sign display area AR15 as a display target area together with a display command for sign information corresponding to the specific regulatory sign. As illustrated in FIG. 6, the sign display area AR15 has a larger area than the sign display area AR11, so that the occupant can easily recognize the sign information. As a result, it is possible to effectively call attention to the occupant. Note that FIG. 6 illustrates an example of a screen on which a temporary stop sign is displayed in the sign display area AR15, but the specific regulatory sign may be a regulatory sign other than the temporary stop sign.

The above embodiment can be combined as desired with one or more of the above modifications. The modifications can also be combined with one another.

According to the present invention, it is possible to appropriately notify the driver of information regarding the road sign.

Above, while the present invention has been described with reference to the preferred embodiments thereof, it will be understood, by those skilled in the art, that various changes and modifications may be made thereto without departing from the scope of the appended claims.

What is claimed is:

1. An information display apparatus comprising:
a display unit provided in a moving body; and
a microprocessor, wherein
the microprocessor is configured to perform:
recognizing a road sign around the moving body, and
controlling the display unit to display sign information corresponding to the road sign in a display area of the display unit based on a result of the recognizing, wherein
the display unit includes a first display unit on which at least the sign information is displayed alone or a plurality of pieces of the sign information are displayed adjacent to each other, and a second display unit present at a position different from the first display unit,
the microprocessor is configured to perform
the controlling including determining whether to display the sign information in the display area of the first display unit or in the display area of the second display unit according to a type of the road sign, and controlling the display unit to display the sign information in the determined display area.

2. The information display apparatus according to claim 1, wherein
the first display unit and the second display unit are different displays.

3. The information display apparatus according to claim 2, wherein
the first display unit is a single display provided on an instrument panel of the moving body, and
the second display unit is a head-up display.

4. The information display apparatus according to claim 3, wherein
in the display area of the first display unit, the sign information corresponding to a road sign indicating an action regulation or a speed limit on the moving body is displayed.

5. The information display apparatus according to claim 3, wherein
in the display area of the second display unit, the sign information corresponding to a road sign indicating a road structure or a road sign indicating entry prohibition is displayed.

6. The information display apparatus according to claim 3, wherein
the microprocessor is further configured to perform recognizing a road structure in a traveling direction of the moving body, and
the microprocessor is configured to perform the controlling including determining a display position of the sign information in the display area of the second display unit based on the road structure.

7. The information display apparatus according to claim 2, wherein
the first display unit has a first display area on which the sign information is displayed alone or a plurality of pieces of the sign information are displayed adjacent to each other, and a second display area different from the first display area.

8. The information display apparatus according to claim 7, wherein
the second display area has a larger area than the first display area.

9. The information display apparatus according to claim 7, wherein
the sign information corresponding to a temporary stop sign is displayed in the second display area.

10. The information display apparatus according to claim 1, wherein
the microprocessor is further configured to perform detecting a behavior of the moving body, and
the microprocessor is configured to perform the controlling including, when the road sign recognized is a road sign indicating an action regulation on the moving body and a behavior violating the action regulation is detected, controlling the display unit such that the sign information corresponding to the road sign is displayed.

11. The information display apparatus according to claim 1, wherein
the microprocessor is further configured to detect a behavior of the moving body, and
the microprocessor is configured to perform the controlling including, when a road sign is recognized, controlling the display unit such that the sign information indicating the road sign is displayed, and when the road sign indicates an action regulation on the moving body and a behavior violating the action regulation is detected, controlling the display unit such that the sign information being displayed is highlighted.
